(19) United States
(12) Patent Application Publication
(10) Pub. No.: US 2016/0350607 A1
(43) Pub. Date: Dec. 1, 2016

(54) BIOMETRIC AUTHENTICATION DEVICE

(71) Applicant: Microsoft Technology Licensing, LLC, Redmond, WA (US)

(72) Inventors: Tomi Sokeila, Kirkland, WA (US); Tommi Tavi, Tampere (FI)

(21) Appl. No.: 14/721,207

(22) Filed: May 26, 2015

(51) Int. Cl. G06K 9/00

(52) U.S. Cl. CPC G06K 9/00885

(57) ABSTRACT

A biometric authentication device is described. In an embodiment, the device comprises an illumination unit operable in a first power mode, a second power mode and a power-off mode, the illumination unit consuming more power in the second power mode than in the first power mode. The device also comprises a detection unit configured to detect a salient object and perform biometric authentication; and a control unit that controls operation of the illumination unit and the detection unit. The control unit is configured to operate the illumination unit in the first power mode when the detection unit is used to detect a salient object, and operate the illumination unit in the second power mode when the detection unit is used to perform biometric authentication. A method and system for biometric authentication are also disclosed.

### BACKGROUND

Biometric authentication such as iris recognition, face recognition or fingerprint recognition often uses light sources to illuminate the subject of identification. Infrared (IR) light can be used in iris recognition as it is invisible to human eye and helps to capture a more detailed iris structure on the image. Also, for example, “night vision” in video cameras may utilize IR light to illuminate a scene in low-light conditions. The IR and other light sources can be switched on in pulses or in periods.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

A biometric authentication device and system are presented. The device has a detection and illumination units which are controlled by a control unit. Illumination unit works at least in two power modes, one running lower power than the other. The device can, in the low-power mode of the illumination unit, scan and detect a salient object nearby, calibrate and finalize detection of the object in a certain position. The second high-power mode of the illumination unit is then switched on for the actual biometric authentication.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of a device according to an embodiment;

FIG. 2 is a block diagram of a system according to an embodiment;

FIG. 3 is a flow chart of a method according to an embodiment;

FIG. 4 is a diagram demonstrating a temperature comparison between setups with pulsing IR light.

Like reference numerals are used to designate like parts in the accompanying drawings.

### DETAILED DESCRIPTION

The detailed description provided below in connection with the appended drawings is intended as a description of the embodiments and is not intended to represent the only forms in which the embodiments may be constructed or utilized. The description sets forth the functions and the sequence of operation steps. However, the same or equivalent functions and sequences may be accomplished by different embodiment not listed below.

Although some of the present embodiments may be described and illustrated herein as being implemented in a smartphone or a tablet computer, these are only examples of a device and not a limitation. As those skilled in the art will appreciate, the present embodiments are suitable for application in a variety of different types of devices incorporating a digital image capture unit or a digital imaging system, for example, a stand-alone digital camera device, e.g. a compact camera, a SLR (Single-Lens Reflex) camera, a mirrorless interchangeable-lens camera, or a stationary camera implemented in an authentication system.

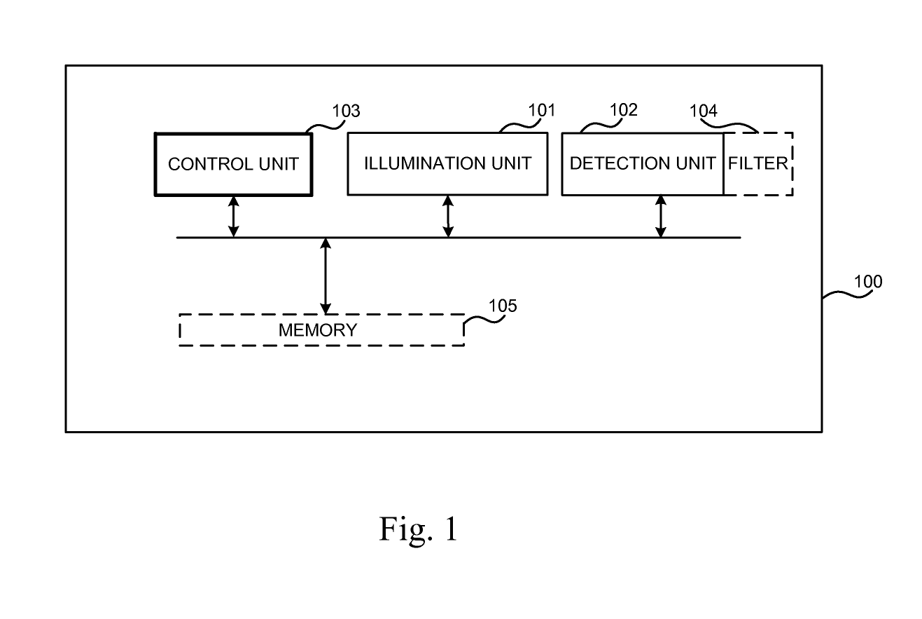

FIG. 1 shows a block diagram of an embodiment of a biometric authentication device 100. The device 100 may be any device which provides authentication functionality based on iris recognition, face recognition, fingerprint recognition or other biometric data. For example, the device 100 may be implemented as a stand-alone digital camera device, or the device 100 may be implemented e.g. in a smartphone, a tablet computer, a wearable camera or a web camera.

The device 100 comprises an illumination unit 101. The illumination unit 101 is operable in a first power mode, a second power mode and a power-off mode. If the device 100 has e.g. a standby mode, the illumination unit 101 may remain in the power-off mode while the device 100 is in standby mode. The illumination unit 101 consumes more power in the second power mode than in the first power mode. This may refer to momentary power consumption in the first and second power modes, or to an average value of power consumed over a period of time in the first and second power modes. For example, if the illumination unit 101 produces light in pulses, average power consumption over a period of time, or momentary power consumption when the light pulsates, may be used. The illumination unit 101 may comprise a light source which produces light with a wavelength above 700 nanometers, for example an infrared (IR) or near infrared (NIR) light-emitting diode (LED). The illumination unit 101 also may comprise a visible-light source such as a flash or a LED producing light with wavelengths of the visible light specter.

The illumination unit 101 may also be operable in power modes other than the first power mode, the second power mode and the power-off mode. For example, the second power mode may be different depending on the outside conditions such as the amount of light, for example sunlight, normal daylight or artificial light.

The device 100 further comprises a detection unit 102. The detection unit 102 is configured to detect a salient object and perform biometric authentication. The detection unit 102 may comprise a proximity sensor for detection of a salient object and a camera for initiating biometric authentication. The camera may be, but is not limited to, a digital photo camera, a video camera, and an IR camera. In an embodiment, the camera is configured to capture images at a framerate between 5 and 60 frames per second (FPS), for example in a video stream that can be used for iris recognition. The camera may also be a high-FPS camera capturing images at framerates higher than 60 FPS. According to an embodiment, the camera may be a digital photo camera configured to captures single images at a rate lower than 5 per second. The detection unit 102 may comprise more than one of the abovementioned cameras. For example, the detection unit 102 may comprise a combination of an IR camera and a video camera.

In biometric authentication such as face recognition one image taken by the camera may be sufficient to complete the authentication.

In an embodiment, the detection unit 102 may also comprise an exposure meter and autofocus element configured to adjust optical properties of the detection unit 102 such that biometric analysis may be started. This can happen for example simultaneously with or after detection of the salient object. The detection unit 102 is not limited to one or more cameras for initiating the biometric authentication, and may comprise at least an optical system including a lens arrangement and an image sensor, such as a charge-coupled device (CCD) sensor or a complementary metal-oxide-semiconductor (CMOS) sensor.

The detected salient object can refer to any object of interest on which biometric authentication can be run. In an embodiment, the salient object may be the head or face of a person, and biometric authentication may be iris recognition. In another embodiment, the salient object may be a finger in close proximity, and biometric authentication may be fingerprint recognition.

The device 100 also comprises a control unit 103 that controls operation of the illumination unit 101 and the detection unit 102. The control unit 103 is configured to switch the illumination unit 101 to the first power mode for the detection of a salient object by the detection unit 102, and switch it to the second power mode for biometric authentication by the detection unit 102. Since more power is consumed in the second power mode than in the first power mode, the control unit 103 is configured to instruct the illumination unit 101 to operate at higher power when actual biometric authentication is performed, and to operate at lower power when salient unit is being detected prior to biometric authentication. In case the illumination unit 101 is operable in more than three power modes, the control unit 103 can be configured to switch the illumination unit 101 to the additional power modes. For example, the control unit 103 may switch the illumination unit 101 to a third power mode for biometric authentication in sunlight conditions, e.g. increasing the power compared to the second power mode to avoid interference from the sunlight. The control unit 103 may also switch the illumination unit 101 to an additional power mode for preliminary detection of the salient object.

According to an embodiment, the illumination unit 101 is configured to emit light in pulses in the second power mode. The pulses may last between 2 and 10 milliseconds. In an embodiment, the illumination unit 101 functions at an electric current between 500 and 1000 milliamperes per pulse in the second power mode, and may consume between 1.8 and 3.2 Watts. It may function at a constant electric current between 50 and 150 milliamperes in the first power mode.

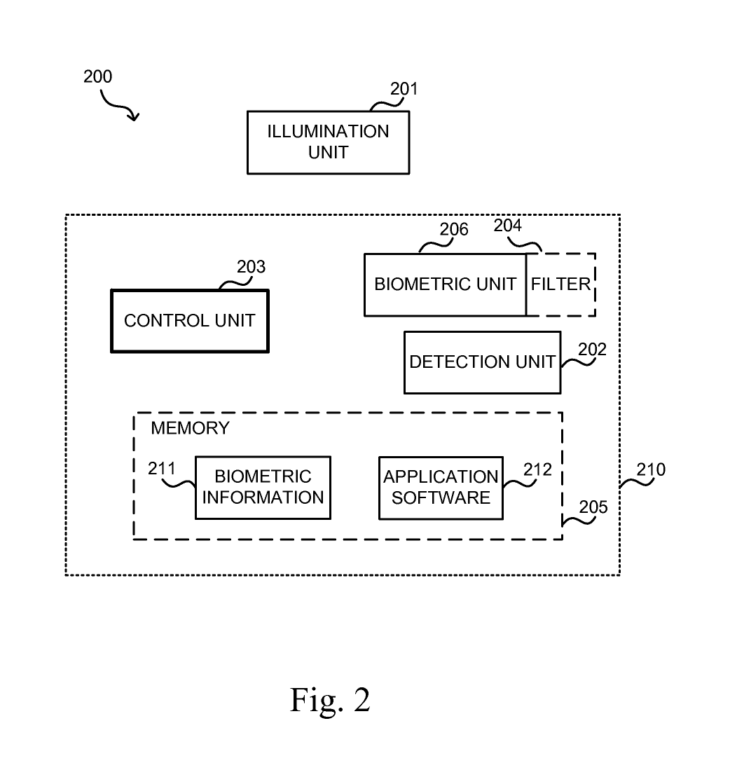

The control unit 103 in one embodiment comprises a processor. This element is described below following the description of FIG. 2.

The detection unit 102 can comprise an optical element 104 configured to filter light with a wavelength above 650 nanometers, or above 700 nanometers. This allows filtering IR light that ends up in the detection unit, including the IR light reflected from the salient object. The optical element 104 may be an optical filter.

In an embodiment, the device 100 comprises a memory 105 configured to store biometric information. The memory may be temporary buffer memory or permanent storage memory for biometric information. The memory 105 may be used by the control unit 103 to complete the biometric authorization process by comparing biometric data gathered by the detection unit 102 with the biometric information stored in the memory 105. The optical element 104 and memory 105 are illustrated by dashed lines as optional elements of the device 100.

In an embodiment, the device 100 is a portable device, for example a mobile phone or a tablet. Alternatively, the device 100 may be implemented as part of a portable device.

The illumination unit 101 may produce heat when used, and is likely to produce more heat in the second (higher) power mode than in the first. Structurally, the illumination unit 101 may be positioned in (or on) the device 100 at a distance between other elements which produce heat or elements which can malfunction because of the heat. In the embodiment where the device 100 is a portable device, such elements can include one or more processors, or a camera which can be affected by heat e.g. when autofocusing.

In an embodiment, the device 100 is implemented as a portable device, and the control unit 103 is configured to activate the first power mode of the illumination unit 101 when the device 100 is picked up by a user. This allows the biometric authentication to start automatically when a user picks up the device 100. If, for example, the device 100 is a mobile phone which has a lock mode, the device 100 may be configured to unlock upon biometric authentication. According to the embodiment, this authentication may start automatically when a user picks up the device 100 and unlock the device when it is complete.

In an embodiment, the device 100 is implemented as a portable device and has a user-operable switch which allows a user to switch between the power modes of the illumination unit 101. For example, if the device 100 is an electronic device and comprises software which requires biometric authentication to be used, a user may switch between the power modes and perform the salient object detection and biometric authentication manually at the appropriate moment.

FIG. 2 shows a block diagram of a system 200 according to an embodiment. The system 200 comprises an illumination unit 201. The illumination unit 201 is operable in a first power mode, a second power mode and a power-off mode. The illumination unit 201 consumes more power in the second power mode than in the first power mode. The illumination unit 201 may also be operable in additional power modes.

The system 200 also comprises a detection unit 202 configured to detect a salient object. The detection unit 202 may comprise a proximity sensor which detects the presence and proximity of a salient object. The system 200 further comprises a biometric authentication unit 206 configured to perform biometric authentication. An optical filter 204 may also be attached to the authentication unit 206 to filter the light of predetermined wavelengths, for example IR or NIR specters. The biometric authentication 206 unit may be an optical fingerprint scanner, an IR camera, a digital photo or video camera or any other suitable biometric apparatus. The biometric authentication unit 206 may comprise more than one camera, for example a combination of an IR camera and a digital video camera. The detection unit 202 and the biometric unit 206 may be implemented in one element, as they are in the embodiment of a biometric authentication device 100 shown on FIG. 1.

The system 200 also comprises a control unit 203 which controls the operation of the illumination unit 201, the detection unit 202 and the biometric authentication unit 206. The control unit 203 is configured to operate the illumination unit 201 in the first power mode when the detection unit 202 is used to detect a salient object, and operate the illumination unit 201 in the second power mode when the biometric authentication unit 206 is used to perform biometric authentication.

Operation of the system 200 is similar to the device 100 exemplified on FIG. 1. Elements of the system 200 may be implemented as separate devices, or some of them may form an intermediate device such as the device 210 shown by a dotted line on FIG. 2. The elements 201, 202 and 206 are operably connected to the control unit 203, which means the connection could be rigid, wired or wireless.

The device 210 may be implemented as any computing device and/or electronic device. The illumination unit 201 may be separated from the device 210 and secured in a predetermined position.

The system 200 may also comprise a memory 205 configured to store biometric information 211. It is shown with a dashed line as an optional element. The memory 205 may also store application software 212 and an operating system (not shown).

The control units 103, 203 of the devices 100, 210 may comprise one or more processors which may be microprocessors, controllers or any other suitable type of processors for processing computer executable instructions to control the operation of the devices 100, 210. Platform software comprising an operating system or any other suitable platform software may be provided at the devices 100, 210 to enable application software 212 to be executed on the device.

Computer executable instructions may be provided using any computer-readable media that is accessible by the devices 100, 210. Computer-readable media may include, for example, computer storage media such as memory 105, 205 and communications media. Computer storage media, such as memory 105, 205 includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 105, 205) is shown within the devices 100, 210 it will be appreciated that the storage may be distributed or located remotely and accessed via a network or other communication link.

At least some of the embodiments disclosed in FIGS. 1-2 can provide reduced heating of the device when biometric authentication is performed, at least partially due to the capability of reducing the time the illumination unit 101, 201 needs to be in the second power mode.

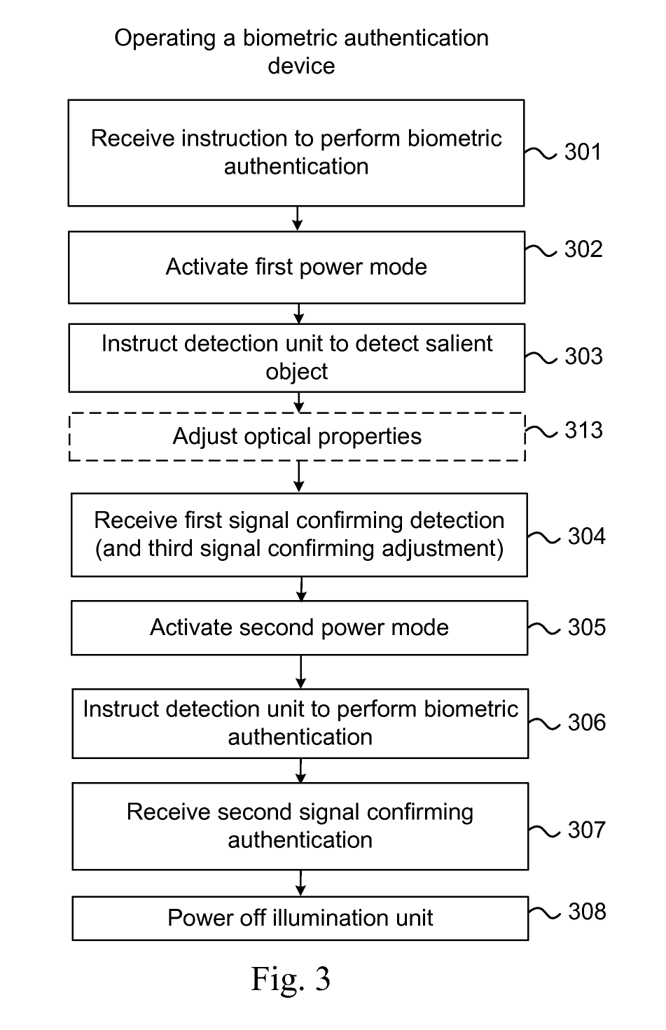

FIG. 3 shows a method for operating a biometric authentication device according to an embodiment. This device comprises an illumination unit operable in a first power mode, a second power mode and a power-off mode, the illumination unit consuming more power in the second power mode than in the first power mode; and a detection unit configured to detect a salient object and perform biometric authentication. The method comprises receiving 301 an instruction to perform biometric authentication. This instruction can be received, for example, from a sensor when the device is picked up by a user, or in any other scenario when biometric authentication is to be performed. The method further comprises activating 302 the first “low” power mode of the illumination unit. With the illumination unit in the first power mode, the detection unit is instructed 303 to perform detection of a salient object. Then, a first signal is received 304 from the detection unit confirming the detection of a salient object, e.g. a signal confirming that the detection is complete. The method then comprises activating 305 the second “high” power mode of the illumination unit based on the received first signal. The detection unit is then instructed 306 to perform biometric authentication while the illumination unit is in the second power mode. Once the authentication is complete, a second signal is received 307 from the detection unit confirming the biometric authentication, and the illumination unit is powered off 308 based on the second signal.

If the illumination unit of the device is operable in power modes other than abovementioned first, second and power-modes, the method may further comprise activating these additional power modes at any stage. In an embodiment, the method may comprise activating an additional power mode of the illumination unit for preliminary detection of a salient object; or activating an additional power mode for more detailed detection. For example, when biometric authentication relates to iris recognition, the method may comprise activating 302 the first power mode to detect a face, then activating an additional “intermediate” power mode to detect the eyes, and then activating 305 the second power mode for iris recognition. In addition, the illumination unit may have alternative power modes for detection and biometric authentication depending on the conditions. In an embodiment, the method comprises monitoring external conditions and defining the first and second power modes of the illumination unit depending on the external conditions. These conditions may include the amount of external light.

The method may further comprise adjusting 313 of the detection unit when the illumination unit is in the first power mode, and receiving at 314 a third signal confirming the adjustment of optical properties of the detection unit. The optical properties adjusted at 313 can be, for example, exposure time and focus of the camera. The second power mode of the illumination unit is activated based on the first signal and the third signal.

The methods according to the embodiments above may be performed, for example, by a control unit of the device or a processor.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The embodiments described above may have the technical effect of reduced heating and power saving during biometric authentication because the high-power second power mode is used only for the actual authentication, for example when iris recognition is being performed, while lower-power first power mode is used during detection of a salient object and calibration.

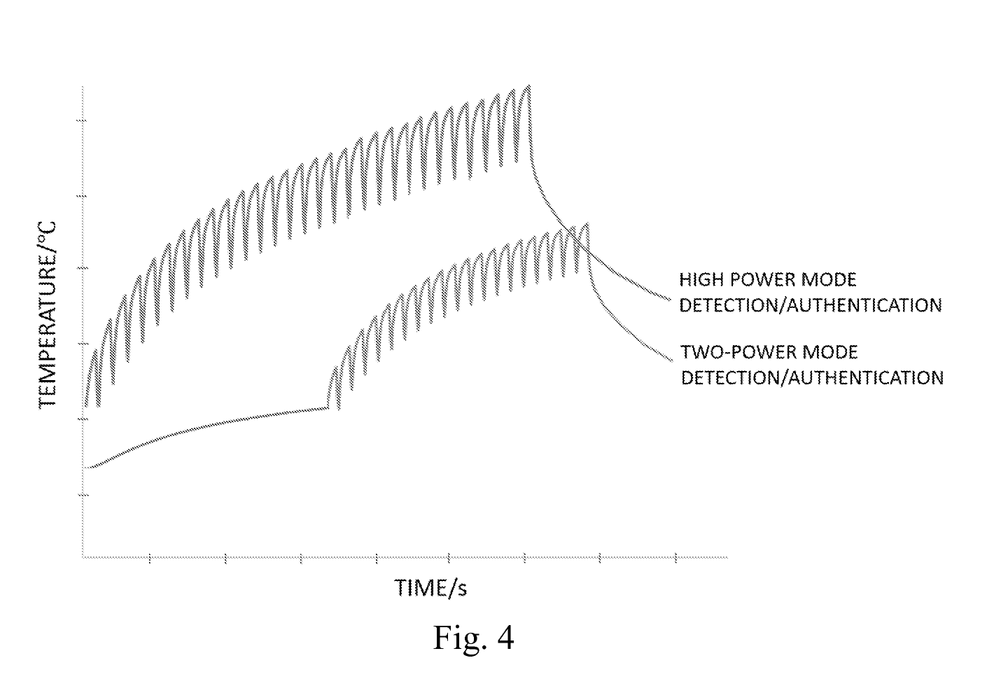

FIG. 4 is a diagram of illumination unit temperature in degrees Celsius against time in seconds. The lower curve represents the process when salient object detection is performed in a first power mode, and the second power mode is activated only for biometric authentication. The upper curve represents the process when both the detection and the authentication are done in one power mode substantially equivalent to the second power mode suitable for biometric authentication. This diagram illustrates the technical effect of reduced heating of the illumination unit, and consequently the whole device, when the second high-power mode is used only for biometric authentication.

The described embodiments may also have a technical effect of improving user experience by removing the need to wait for the device to cool down after several pulses (or seconds) of light emitted by the illumination unit.

According to an aspect, a biometric authentication device is provided. The device comprises an illumination unit operable in a first power mode, a second power mode and a power-off mode, the illumination unit consuming more power in the second power mode than in the first power mode. The device also comprises a detection unit configured to detect a salient object and perform biometric authentication, and a control unit that controls operation of the illumination unit and the detection unit. The control unit is configured to: operate the illumination unit in the first power mode when the detection unit is used to detect a salient object, and operate the illumination unit in the second power mode when the detection unit is used to perform biometric authentication.

In an embodiment, the illumination unit comprises an infrared light source.

In an embodiment, in addition to the above embodiment, the infrared light source is an infrared light-emitting diode.

In an embodiment, alternatively or in addition to the above embodiments, the illumination unit comprises a visible-light source.

In an embodiment, alternatively or in addition to the above embodiments, the detection unit comprises a camera.

In an embodiment, alternatively or in addition to the above embodiments, the camera is configured to capture images at a framerate between 5 and 60 frames per second.

In an embodiment, alternatively or in addition to the above embodiments, the detection unit comprises a proximity sensor.

In an embodiment, alternatively or in addition to the above embodiments, the illumination unit comprises an optical element configured to filter light with a wavelength above 650 nanometers.

In an embodiment, alternatively or in addition to the above embodiments, the illumination unit is configured to emit light in pulses which last between 2 and 10 milliseconds in the second power mode.

In an embodiment, alternatively or in addition to the above embodiments, the illumination unit functions at an electric current between 500 and 1000 milliamperes per pulse in the second power mode.

In an embodiment, alternatively or in addition to the above embodiments, the detection unit is configured to detect a head or a face of a person as a salient object and perform iris recognition as biometric authentication.

In an embodiment, alternatively or in addition to the above embodiments, the control unit comprises a processor.

In an embodiment, alternatively or in addition to the above embodiments, the device comprises a memory configured to store biometric information.

In an embodiment, the device of any of the above embodiments is a portable device. In an embodiment, a mobile apparatus comprises the device according to any of the above embodiments.

In an embodiment, in addition to the above embodiments, the control unit is configured to activate the first power mode of the illumination unit when the device is picked up by a user.

In an embodiment, alternatively or in addition to the above embodiments, the device comprises a user-operable switch configured to switch between the power modes of the illumination unit.

According to an aspect, a system is provided. The system comprises: a detection unit configured to detect a salient object, a biometric authentication unit configured to perform biometric authentication, an illumination unit operable in a first power mode, a second power mode and a power-off mode, the illumination unit consuming more power in the second power mode than in the first power mode; and a control unit that controls the operation of the illumination unit, the detection unit and the biometric authentication unit. The control of the system unit is configured to: operate the illumination unit in the first power mode when the detection unit is used to detect a salient object, and operate the illumination unit in the second power mode when the biometric authentication unit is used to perform biometric authentication. The illumination unit, the detection unit and the biometric authentication unit are operably connected to the control unit in the system.

According to an aspect, a method for operating a biometric authentication device is provided. The biometric authentication device comprises an illumination unit operable in a first power mode, a second power mode and a power-off mode, the illumination unit consuming more power in the second power mode than in the first power mode, and a detection unit configured to detect a salient object and perform biometric authentication. The method comprises: receiving an instruction to perform biometric authentication, activating the first power mode of the illumination unit, instructing the detection unit to perform detection of a salient object while the illumination unit is in the first power mode, receiving a first signal from the detection unit confirming the detection of a salient object, activating the second power mode of the illumination unit based on the first signal, instructing the detection unit to perform biometric authentication while the illumination unit is in the second power mode, receiving a second signal from the detection unit confirming the biometric authentication, and activating the power-off mode of the illumination unit based on the second signal.

In an embodiment, alternatively or in addition to the above embodiments, the biometric authentication device is a portable device, and the instruction to perform biometric authentication is received when the device is operated by a user.

In an embodiment, alternatively or in addition to the above embodiments, the method comprises adjusting optical properties of the detection unit when the illumination unit is in the first power mode, and receiving a third signal confirming the adjustment of optical properties of the detection unit, wherein activating the second power mode of the illumination unit comprises activating the second power mode based on the first signal and the third signal.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the technical effects described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term ‘comprising’ is used herein to mean including the method blocks or elements identified, but that such blocks or elements do not comprise an exclusive list and a method or device may contain additional blocks or elements.

It will be understood that the above description is given by way of example only and that various modifications may be made by those skilled in the art. The above specification, embodiments and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A biometric authentication device, comprising:
an illumination unit operable in a first power mode, a second power mode and a power-off mode, the illumination unit consuming more power in the second power mode than in the first power mode;
a detection unit configured to detect a salient object and perform biometric authentication; and
a control unit that controls operation of the illumination unit and the detection unit;
wherein the control unit is configured to:
operate the illumination unit in the first power mode when the detection unit is used to detect a salient object, and
operate the illumination unit in the second power mode when the detection unit is used to perform biometric authentication.

2. A device as claimed in claim 1, wherein the illumination unit comprises an infrared light source.

3. A device as claimed in claim 2, wherein the infrared light source is an infrared light-emitting diode.

4. A device as claimed in claim 1, wherein the illumination unit comprises a visible-light source.

5. A device as claimed in claim 1, wherein the detection unit comprises a camera.

6. A device as claimed in claim 5, wherein the camera is configured to capture images at a framerate between 5 and 60 frames per second.

7. A device as claimed in claim 1, wherein the detection unit comprises a proximity sensor.

8. A device as claimed in claim 1, wherein the illumination unit comprises an optical element configured to filter light with a wavelength above 650 nanometers.

9. A device as claimed in claim 1, wherein the illumination unit is configured to emit light in pulses which last between 2 and 10 milliseconds in the second power mode.

10. A device as claimed in claim 9, wherein the illumination unit functions at an electric current between 500 and 1000 milliamperes per pulse in the second power mode.

11. A device as claimed in claim 1, wherein the detection unit is configured to detect a head or a face of a person as a salient object and perform iris recognition as biometric authentication.

12. A device as claimed in claim 1, wherein the control unit comprises a processor.

13. A device as claimed in claim 1 comprising a memory configured to store biometric information.

14. A device as claimed in claim 1, wherein the device is a portable device.

15. A device as claimed in claim 14, wherein the control unit is configured to activate the first power mode of the illumination unit when the device is picked up by a user.

16. A device as claimed in claim 14 comprising a user-operable switch configured to switch between the power modes of the illumination unit.

17. A system, comprising:
a detection unit configured to detect a salient object,
a biometric authentication unit configured to perform biometric authentication,
an illumination unit operable in a first power mode, a second power mode and a power-off mode, the illumination unit consuming more power in the second power mode than in the first power mode, and
a control unit that controls the operation of the illumination unit, the detection unit and the biometric authentication unit; wherein
the control unit is configured to: operate the illumination unit in the first power mode when the detection unit is used to detect a salient object, and operate the illumination unit in the second power mode when the biometric authentication unit is used to perform biometric authentication, and
the illumination unit, the detection unit and the biometric authentication unit are operably connected to the control unit.

18. A method for operating a biometric authentication device, the device comprising:
an illumination unit operable in a first power mode, a second power mode and a power-off mode, the illumination unit consuming more power in the second power mode than in the first power mode; and
a detection unit configured to detect a salient object and perform biometric authentication;
wherein the method comprises:
receiving an instruction to perform biometric authentication,
activating the first power mode of the illumination unit,
instructing the detection unit to perform detection of a salient object while the illumination unit is in the first power mode,
receiving a first signal from the detection unit confirming the detection of a salient object,
activating the second power mode of the illumination unit based on the first signal,
instructing the detection unit to perform biometric authentication while the illumination unit is in the second power mode,
receiving a second signal from the detection unit confirming the biometric authentication, and
activating the power-off mode of the illumination unit based on the second signal.

19. A method as claimed in claim 18, wherein the biometric authentication device is a portable device, and the instruction to perform biometric authentication is received when the portable device is operated by a user.

20. A method as claimed in claim 18, comprising adjusting optical properties of the detection unit when the illumination unit is in the first power mode, and receiving a third signal confirming the adjustment of optical properties of the detection unit, wherein activating the second power mode of the illumination unit comprises activating the second power mode based on the first signal and the third signal.
